(19) United States
(12) Patent Application Publication
(10) Pub. No.: US 2026/0251619 A1
(43) Pub. Date: Aug. 27, 2026

(54) METHOD OF NON-LINEAR NON-DESTRUCTIVE TESTING OF A TESTPIECE

(71) Applicant: Theta Technologies Ltd, Exeter (GB)

(72) Inventors: Julian Roger Wright, Exeter, Devon (GB); James Watts, Exeter, Devon (GB); Daniel Rodriguez Sanmartin, Exeter, Devon (GB); Alex Brennan, Exeter, Devon (GB); Daniel Preston, Exeter, Devon (GB); Aamir Ali Ghouri, Exeter, Devon (GB); Yordan Ramshev, Exeter, Devon (GB)

(21) Appl. No.: 18/870,786

(22) PCT Filed: Jun. 1, 2023
(86) PCT No.: PCT/GB2023/051456

§ 371 Date: Dec. 2, 2024

(30) Foreign Application Priority Data
Jun. 1, 2022 (GB) 2208104.6

(51) Int. Cl. G01N 29/12; G01N 29/04; G01N 29/34

(52) U.S. Cl. CPC G01N 29/12; G01N 29/045; G01N 29/348; G01N 2291/014; G01N 2291/0289

(57) ABSTRACT

A method of non-linear acoustic non-destructive testing of a testpiece (3) comprising (i) determining a resonance frequency of a testpiece (3) by applying at least one excitation vibration to the testpiece (3) and analysing a vibrational response of the testpiece (3) to the at least one excitation vibration, (ii) applying at least one excitation vibration to the testpiece (3) at the determined resonance frequency and/or over a range of frequencies that includes the determined resonance frequency, and (iii) determining if the testpiece (3) has one or more flaws by analysing a vibrational response of the testpiece, to the at least one excitation vibration in step (ii), for non-linear behaviour. An apparatus (1) for non-linear acoustic non-destructive testing of a testpiece (3) according to the method.

### FIELD OF THE INVENTION

The present invention relates to a method of non-linear acoustic non-destructive testing of a testpiece. The present invention also relates to an apparatus for non-linear acoustic non-destructive testing of a testpiece, wherein the apparatus comprises a computer configured to operate the apparatus to carry out the method.

### BACKGROUND OF THE INVENTION

Non-linear acoustic non-destructive testing (also referred to as Nonlinear Elastic Wave Spectroscopy) is an emerging field of non-destructive testing (NDT) which may allow for a much earlier detection of one or more flaws in a testpiece (e.g. a part of a structure, machine, vehicle, etc., being tested) than most conventional NDT methods.

Conventional linear materials conform to Hooke's Law, exhibiting a linear relationship between stress and strain. However, testpieces containing certain kinds of flaw may exhibit non-linear stress-strain behaviour.

One such approach is based on the generation of non-linear behaviour caused by ‘clapping’ and/or ‘stick-slip friction’ behaviour in and around a defect, as detailed in (i) New Opportunities for NDT Using Non-Linear Interaction of Elastic Waves with Defects, I. Solodov, D. Döring, G. Busse, Strojniški vestnik—Journal of Mechanical Engineering 57 (2011) 3, 169-182. DOI: 10.5545/sv-jme.2010.168 and (ii) Nonlinear ElasticWave Spectroscopy (NEWS) Techniques to Discern Material Damage, Part I: Nonlinear Wave Modulation Spectroscopy (NWMS), K. E.-A. Van Den Abeele, P. A. Johnson, A. Sutin, Res Nondestr Eval (2000) 12:17-30, DOI: 10.1007=s001640000002.

In this respect, structures containing high-aspect-ratio flaws, for example, can exhibit non-linear behaviour under certain conditions. At a sufficiently low input energy level, no non-linearity will be observed in the testpiece. This is because the crack-like feature is not sufficiently exercised to cause contact between its two faces, to lead either to the ‘clapping’ and/or stick-slip friction behaviour. At a sufficiently high input energy level, either or both of these behaviours will be stimulated, and non-linearity will become apparent. From this it is possible to infer, and potentially locate, the existence of one or more flaws.

However, it is often the case that a flaw in a testpiece will constitute only a very small fraction of the volume of that testpiece, and that the stiffness of the testpiece will be such that stimulation of non-linear behaviour (for example clapping or stick-slip behaviour (e.g. where the flaw is a crack)), will be difficult. Such a problem may occur in relation to any type of flaw that may exhibit non-linear behaviour. Therefore, it is often necessary to ensure sufficiently high input energy into a testpiece, to stimulate non-linear behaviour, but it can be extremely difficult to do this without risk of damaging the testpiece.

The present invention seeks to address or mitigate at least some of the above-mentioned problems. Alternatively, or additionally, the present invention seeks to provide an improved method of non-linear acoustic non-destructive testing of a testpiece. Alternatively, or additionally, the present invention seeks to provide an improved apparatus for non-linear acoustic non-destructive testing of a testpiece.

### SUMMARY OF THE INVENTION

According to a first aspect of the invention there is provided a method of non-linear acoustic non-destructive testing of a testpiece comprising:
(i) Determining a resonance frequency of a testpiece by applying at least one excitation vibration to the testpiece and analysing a vibrational response of the testpiece to the at least one excitation vibration;
(ii) Applying at least one excitation vibration to the testpiece at the determined resonance frequency and/or over a range of frequencies that includes the determined resonance frequency, and
(iii) Determining if the testpiece has one or more flaws by analysing a vibrational response of the testpiece, to the at least one excitation vibration in step (ii), for non-linear behaviour.

Applying at least one excitation vibration to the testpiece at the determined resonance frequency and/or over a range of frequencies that includes the determined resonance frequency, may provide a relatively high input energy into the testpiece, thereby increasing the likelihood that any non-linear behaviour, due to one or more flaws in the testpiece, will be induced.

It will be appreciated that where step (i) comprises applying a plurality of excitation vibrations to the testpiece, step (i) may comprise analysing a vibrational response of the testpiece to each excitation vibration.

It will be appreciated that where step (ii) comprises applying a plurality of excitation vibrations to the testpiece, step (iii) may comprise analysing a vibrational response of the testpiece to each excitation vibration.

Optionally step (i) comprises outputting a signal representative of the determined resonance frequency.

Optionally step (iii) comprises outputting a signal representative of whether the testpiece is determined to have one or more flaws.

In each case, the output signal may for example, be a graph, data, a true or false signal, etc.

Optionally step (i) comprises:
(i)(a) Making a first determination of a resonance frequency of a testpiece by applying at least one excitation vibration to the testpiece and analysing a vibrational response of the testpiece to the at least one excitation vibration;
(i)(b) Determining if the first determination of the resonance frequency is a true resonance frequency of the testpiece and, if it is determined not to be a true resonance frequency, performing an analysis to provide a second determination of the resonance frequency that is closer to, and/or at, the true resonance frequency.

This may allow for the identification of the resonance frequency to take account of potentially obfuscating factors, such as degenerate modes (due to anisotropy or geometrical asymmetry) and/or beat frequencies.

Optionally, where the first determination of the resonance frequency is determined to be a true resonance frequency, the determined resonance frequency, referred to in steps (i) or (ii) or in relation to step (iii) (e.g. see claims 7 and 8 as filed and related consistory clauses) is the first determination of the resonance frequency.

Optionally, where a second determination of the resonance frequency is made, the determined resonance frequency, referred to in steps (i) or (ii) or in relation to step (iii) (e.g. see claims 2 and 9 as filed and related consistory clauses) is the second determination of the resonance frequency.

Optionally step (i) comprises:
(i)(a) applying a first excitation vibration to the testpiece over a range of frequencies and making a first determination of a resonance frequency of the testpiece from an analysis of a vibrational response of the testpiece to the first excitation vibration;
(i)(b) applying a second excitation vibration to the testpiece at, and/or over a frequency range that the first determination the includes, of resonance frequency in step (i)(a) and making a second determination of the resonance frequency from an analysis of a vibrational response of the testpiece to the second excitation vibration.

Optionally step (i)(b) comprises analysing a vibrational response of the testpiece to the second excitation vibration to determine if the first determination of the resonance frequency is a true resonance frequency, based on the vibrational response to the second excitation.

Optionally step (i) comprises:
(i)(a) applying a first excitation vibration to the testpiece over a range of frequencies, at a first frequency resolution, identifying a response peak in the vibrational response, to the first excitation vibration and making a first determination of a resonance frequency of the testpiece to be the frequency at which the identified response peak occurs;
(i)(b) applying a second excitation vibration to the testpiece over a range of frequencies that includes the first determination of the resonance frequency from step (i)(a), and is applied at a second frequency resolution that is finer than the first frequency resolution, and analysing a vibrational response of the testpiece to the second excitation vibration to provide a second determination of the resonance frequency.

It will be appreciated that, where an excitation vibration is applied over a range of frequencies, the excitation vibration is applied at a plurality of frequencies in this range.

Optionally step (i)(b) comprises analysing a vibrational response of the testpiece to the second excitation vibration to determine if the response peak identified in step (i)(a) is a true resonance peak, based on the vibrational response to the second excitation, and:
if the response peak is determined not to be a true resonance peak of the testpiece, based on the vibrational response to the second excitation vibration, analysing the vibrational response to the second excitation vibration to identify a further response peak that is determined to be a true resonance peak, based on the vibrational response to the second excitation vibration, determining the frequency at which that further response peak occurs and making a second determination of the resonance frequency to be the frequency at which the further response peak is determined to occur at; or
if the response peak is determined to be a true resonance peak of the testpiece, based on the vibrational response to the second excitation vibration, making a second determination of the resonance frequency to be the first determination of the resonance frequency.

Optionally step (i)(b) is repeated to provide further determinations of the resonance frequency. In this respect, optionally step (i)(b) is repeated to a apply a further excitation vibration to the testpiece over a range of frequencies that includes the previous determination of the resonance frequency and is applied at a frequency resolution that is finer than the frequency resolution of the previous excitation vibration, and analysing a vibrational response of the testpiece to the further excitation vibration to provide a further determination of the resonance frequency. The resonance frequency determined in step (i) may be the final determined resonance frequency.

It will be appreciated that the final two excitation vibrations may be regarded as ‘first and second excitation vibrations’ and the ‘first and second excitation vibrations’ do not need to be applied numerically first and second, where such a repeated step (i)(b) is used.

Optionally, where a second determination of the resonance frequency is made, the determined resonance frequency, referred to in steps (i) or (ii) and in relation to step (iii) (e.g. see claims 2 and 9 as filed and related consistory clauses) is the second determination of the resonance frequency.

A said analysis of a vibrational response may be an analysis of one or more vibrational response values. In this respect, a vibrational response value may be any value illustrative of the vibrational response of the testpiece to the respective excitation vibration. For example, the vibrational response value may be representative of one or more of velocity, acceleration, displacement, etc. of one or more locations on the testpiece, in response to the respective excitation vibration. The vibrational response value may, for example, be one or more of a true value, normalised value, logarithmic value, transformed value (e.g. using a Fast Fourier Transform (FFT)) etc. The analysis may comprise using a Fast Fourier Transform (FFT).

The vibrational response may, for example, be a variation of one or more vibrational response values in the frequency and/or time domain (e.g. the variation of one or more vibrational response values with the frequency of the response to the respective excitation vibration and/or with time following or during the respective excitation vibration, for example).

A response peak may be a peak in the variation of a vibrational response value, for example a peak in the variation of a vibrational response value with frequency (e.g. the frequency of the response to the respective excitation vibration) and/or with time (for example following or during the respective excitation vibration). The response peak may be one of a plurality of response peaks of the vibrational response.

The frequency of a response peak may, for example, be determined using a Fast Fourier Transform. However, it will be appreciated that any suitable method of determining a response peak may be used.

A response peak, and the response peak frequency, (i.e. the response frequency at which the response peak occurs) may be determined by a computer, for example a computer configured through suitable hardware and software, to perform said analysis. Alternatively, or additionally, the response peak and the response peak frequency may be determined by a user, for example by a user viewing an output (e.g. a graph) of the vibrational response and visually determining where the response peak occurs.

Optionally step (i)(a) comprises selecting a response peak from a plurality of response peaks, within the respective frequency range, and determining the frequency at which the selected response peak occurs, to provide said estimated resonance frequency.

A response peak may be selected by a computer, for example a computer configured through suitable hardware and software, to perform said selection.

Alternatively, or additionally, a response peak may be selected by a user, for example by a user viewing an output (e.g. a graph) of the vibrational response.

In either case, the selection may be based on a defined selection criteria, for example which response peak may be the least complex to perform a second excitation vibration on and analyse the vibrational response to the second excitation vibration.

Optionally the second excitation vibration is applied over a frequency range that is smaller than the frequency range of the first excitation vibration. However, the first and second frequency ranges may be the same.

Preferably the same vibrational response value is analysed for the first and second excitation vibrations. However, different vibrational response values may be analysed.

Optionally:
in step (i)(b), the second excitation vibration is at the first determination of the resonance frequency from step (i)(a), and wherein
step (i)(b) comprises analysing a vibrational response of the testpiece to the second excitation vibration to determine if a beat frequency is present, and based on whether or not a beat frequency is determined to be present, making a second determination of the resonance frequency.

This may provide a particularly fast and accurate way of identifying the resonance frequency of the testpiece, as only a single frequency excitation is required.

Optionally:
if a beat frequency is determined to be present, step (i)(b) comprises making a second determination of the resonance frequency from the frequency of the second excitation vibration and the beat frequency; or
if a beat frequency is determined not to be present, step (i)(b) comprises making a second determination of the resonance frequency to be the first determination of the resonance frequency.

Optionally if a beat frequency is determined to be present, step (i)(b) comprises making a second determination of the resonance frequency by adding or subtracting the beat frequency to/from the frequency of the second excitation vibration.

Optionally step (i)(a) comprises applying a first excitation vibration to the testpiece over a range of frequencies, identifying a response peak in the vibrational response, to the first excitation vibration and making a first determination of a resonance frequency of the testpiece to be the frequency at which the identified response peak occurs.

Optionally, in step (i)(b), the second excitation vibration is applied to the testpiece only at the first determination of the resonance frequency, i.e. a single frequency excitation.

Optionally step (ii) comprises applying at least one excitation vibration to the testpiece at the determined resonance frequency. Optionally step (ii) comprises applying at least one excitation vibration to the testpiece over a range of frequencies that includes the determined resonance frequency.

Optionally step (ii) comprises applying at least one excitation vibration to the testpiece at the second determination of the resonance frequency and/or over a range of frequencies that includes the second determination of the resonance frequency. The second determination of the resonance frequency may be the true resonance frequency.

Optionally, where a second determination of the resonance frequency is made, the determined resonance frequency, referred to in steps (i) or (ii) or in relation to step (iii) (e.g. see claims 9 and 2 as filed and related consistory clauses) is the second determination of the resonance frequency.

Optionally, where an excitation vibration is applied to the testpiece, the vibrational response of the testpiece to the excitation vibration is analysed to determine if a beat frequency is present and this is accounted for when making the respective determination of resonance frequency.

Optionally step (ii) comprises applying at least one excitation vibration to the testpiece at the determined resonance frequency. The at least one excitation vibration may be applied to the testpiece only at the determined resonance frequency.

Optionally step (ii) comprises applying at least one excitation vibration to the testpiece over a range of frequencies that includes the determined resonance frequency.

Optionally the frequency sweep is performed slow enough, i.e. at a low enough rate of change of frequency with time, to prevent beat frequencies occurring.

Optionally step (iii) comprises determining if the testpiece has one or more flaws by analysing a vibrational response of the testpiece, to the at least one excitation vibration in step (ii), for harmonics of the determined resonance frequency.

Optionally the analysis of the vibrational response comprises analysing for one or more response peaks at harmonics of the determined resonance frequency.

Optionally step (iii) comprises determining if the testpiece has one or more flaws by analysing a vibrational response of the testpiece, to the at least one excitation vibration in step (ii), for interharmonics of the determined resonance frequency.

Optionally the analysis of the vibrational response comprises analysing for one or more response peaks at interharmonics of the determined resonance frequency.

Optionally the analysis for interharmonics of the determined resonance frequency comprises determining a plurality of harmonics of the determined resonance frequency and, in respect of each of said plurality of harmonics, masking the vibrational response, from the analysis for interharmonics, within a guard band that contains the harmonic, wherein the guard bands have substantially the same bandwidth. Optionally the guard bands extend substantially the same frequency range above the frequency of the respective harmonic as each other and extend substantially the same frequency range below the frequency of the respective harmonic as each other.

Optionally each guard band is substantially centred on the frequency of the respective harmonic.

Optionally step (iii) comprises determining if the testpiece has one or more flaws by analysing a vibrational response of the testpiece, to the at least one excitation vibration in step (ii), for mode coupling.

Optionally of the vibrational response comprises analysing for one or more response peaks that are illustrative of mode coupling.

In this respect, optionally the presence of mode coupling is determined by analysing for one or more response peaks at resonance frequencies of other modes of vibration of the testpiece.

In step (ii) the range of frequencies that includes the determined resonance frequency may be centred on the determined resonance frequency. Alternatively, the range of frequencies that includes the determined resonance frequency may not be centred on the determined resonance frequency. In this respect, any suitable range may be used that includes the determined resonance frequency.

In embodiments of the invention the first and second excitation vibrations excite the testpiece with acoustic vibration.

According to a second aspect of the invention there is provided a computer program product comprising instructions which, when the program is executed by a computer, cause the computer to carry out the method of any of the steps of any preceding aspect of the invention.

According to a third aspect of the invention there is provided an apparatus for non-linear acoustic non-destructive testing of a testpiece, wherein the apparatus comprises a computer configured to operate the apparatus and carry out the method of any of the steps of any preceding aspects of the invention.

The apparatus comprise at least one transducer configured to apply excitation vibration to a testpiece. The apparatus may comprise at least one transducer configured to measure at least one vibrational response value of the vibrational response of a testpiece to an excitation vibration. Said at least one transducers may be the same transducer or may be different transducers. The apparatus may comprise an analysis and control unit. The analysis and control unit may comprise at least one input device for receiving input commands. The apparatus may comprise at least one output device configured to output a signal representative of said vibrational analysis. The at least one input device may be operatively connected to the computer. The at least one output device may be operatively connected to the computer.

Optionally the computer is configured to execute the computer program product according to the second aspect of the invention.

The features of any of the above aspects of the invention may be combined with one or more features of any of the other aspects of the invention, in any combination.

Other preferred and advantageous features of the invention will be apparent from the following description.

### DESCRIPTION OF THE DRAWINGS

A specific embodiment of the invention will now be described with reference to the description and drawings.

FIG. 1 shows a schematic diagram of an apparatus for performing non-linear acoustic non-destructive testing on a testpiece in accordance with an embodiment of the invention;

FIG. 2 is a graph showing the variation of the amplitude of the velocity (dB) of a test location on a testpiece, with the frequency (Hz) of vibration of the testpiece at the test location, in response to an applied input excitation vibration, to illustrate split frequency peaks due to degenerate modes and/or beat frequencies;

FIG. 3 is a graph showing the variation of the amplitude of the velocity (dB) of a test location on a testpiece, with the frequency (Hz) of vibration of the testpiece at the test location, in response to an applied input excitation vibration, to illustrate how a true resonance peak may be obscured by a degenerate mode and/or beat frequency;

FIG. 4a is a graph showing the variation of the amplitude of the velocity (represented by the voltage (V) of the vibration detector) of a test location on a testpiece, with time(s) to an applied input excitation vibration, that has a frequency that is increasing over time, to illustrate the generation of beat frequencies;

FIG. 4b is a graph containing three lines showing the variation of the amplitude of the velocity (dB) of a test location on the testpiece, with the frequency (Hz) of vibration of the testpiece at the test location, in response to an applied input excitation vibration, in each of the windows B1, B2, B3 labelled in FIG. 4a, to illustrate the generation of split response peaks due to beat frequencies;

FIG. 5 is a flow-chart showing the steps in a method of non-linear acoustic non-destructive testing of a testpiece, according to an embodiment of the invention;

FIG. 6 is a flow-chart showing the sub-steps of the first step of the method shown in FIG. 5;

FIG. 7 is a graph showing the variation of the amplitude of the velocity (dB) of a test location on a first testpiece, with the frequency (Hz) of vibration of the testpiece at the test location, in response to an applied first excitation vibration, in sub-step (i)(a) in FIG. 6, using the test apparatus in FIG. 1, illustrating the presence of multiple response peaks of the testpiece;

FIG. 8 is a graph showing the variation of the normalised amplitude of the velocity (dB) of the test location on the first testpiece, with the frequency (Hz) of vibration of the testpiece at the test location, in response to a second excitation vibration, in a first embodiment of sub-step (i)(b) in FIG. 6;

FIG. 9a is a graph showing the variation of the amplitude of the velocity (represented by the voltage (V) of the vibration detector) of a test location on a second testpiece, with time(s) in response to a second excitation vibration, in a second embodiment of sub-step (i)(b) in FIG. 6, where the second excitation vibration is not at a true resonance frequency of the testpiece;

FIG. 9b is a graph corresponding to that of FIG. 9a, but where the second excitation vibration is at a true resonance frequency of the testpiece;

FIG. 10a is a graph showing the variation of the amplitude of the velocity (dB) of a test location on a non-flawed version of a third testpiece, with the frequency (Hz) of vibration of the testpiece at the test location, in response to an excitation vibration at a resonance frequency of the testpiece, as determined in step (i), to examine for harmonics;

FIG. 10b is a graph showing the variation of the amplitude of the velocity (dB) of the test location on a flawed version of the third testpiece, with the frequency (Hz) of vibration of the testpiece at the test location, in response to an excitation vibration at a resonance frequency of the testpiece, as determined in step (i), to examine for harmonics;

FIG. 10c is a graph showing the variation of the amplitude of the velocity (dB) of the test location on a non-flawed version of a fourth testpiece, with the frequency (Hz) of vibration of the testpiece at the test location, in response to an excitation vibration at a resonance frequency of the testpiece, as determined in step (i), to examine for interharmonics;

FIG. 10d is a graph showing the variation of the amplitude of the velocity (dB) of the test location on a flawed version of the fourth testpiece, with the frequency (Hz) of vibration of the testpiece at the test location, in response to an excitation vibration at a resonance frequency of the testpiece, as determined in step (i), to examine for interharmonics;

FIG. 10e is a graph showing the variation of the amplitude of the velocity (dB) of the test location on a non-flawed version of a fifth testpiece, with the frequency (Hz) of vibration of the testpiece at the test location, in response to an excitation vibration across a range of excitation frequencies that includes the resonance frequency of the testpiece as determined in step (i), to examine for mode coupling;

FIG. 10f is a graph showing the variation of the amplitude of the velocity (dB) of the test location on a flawed version of the fifth testpiece, with the frequency (Hz) of vibration of the testpiece at the test location, in response to an excitation vibration across a range of excitation frequencies that includes the resonance frequency of the testpiece as determined in step (i), to examine for mode coupling;

FIG. 10g is a graph showing the variation of the amplitude of the velocity (dB) of the test location on a flawed version of a sixth testpiece, with the frequency (Hz) of vibration of the testpiece at the test location, in response to an excitation vibration across a range of excitation frequencies that includes the resonance frequency of the testpiece as determined in step (i), to examine for interharmonics, where guard bands are used that have a bandwidth proportional to the order of the harmonic;

FIG. 10h is a graph corresponding to that of FIG. 10g, but zoomed in on the region around the second harmonic;

FIG. 10i is a graph corresponding to that of FIG. 10g, but where guard bands are used that have a substantially constant bandwidth, and

FIG. 10j is a graph corresponding to that of FIG. 10i, but zoomed in on the region around the second harmonic.

### DETAILED DESCRIPTION

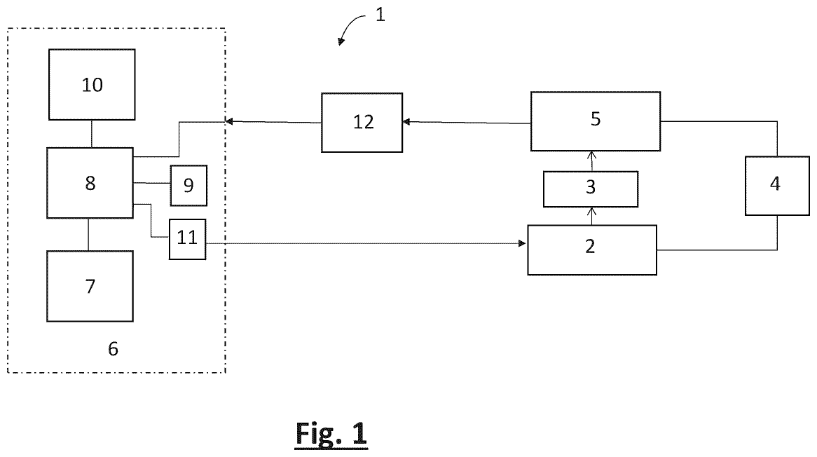

Referring to FIG. 1, there is shown a schematic diagram of an apparatus 1 for performing non-linear acoustic non-destructive testing of a testpiece 3, in accordance with an embodiment of the invention.

The testpiece 3 may be of any type, for example a whole or part of a structure, machine, vehicle, etc.

The apparatus 1 comprises a first transducer in the form of an acoustic vibration generator 2. A testpiece 3, that is to be tested for flaws, is mounted on the acoustic vibration generator 2. In the currently described embodiment the acoustic vibration generator 2 is a shaker powered by an electromagnetic actuator. However, it will be appreciated that any suitable type of acoustic vibration generator may be used, including an electromagnetic shaker; piezoelectric element(s); water-coupled sound, etc.

The acoustic vibration generator 2 is configured to provide an acoustic excitation vibration to the testpiece 3. In the currently described embodiment the acoustic vibration generator 2 applies the excitation vibration to a single location on the testpiece 3. However it will be appreciated that, alternatively, the acoustic vibration generator 2 could apply the excitation vibration to a plurality of locations on the testpiece 3. The excitation vibration induces mechanical waves in the testpiece 3, typically in the form of compression waves. It will be appreciated that the invention is not limited to a particular type of wave.

In one described embodiment the acoustic vibration generator 2 is configured to provide an excitation vibration in the frequency range 5 Hz to 13 kHz (kilohertz) (i.e. 13,000 Hz). However, it will be appreciated that any suitable frequency range may be used. In this respect, the vibration may be in the audible frequency range (i.e. greater than or equal to 20 Hz and less than or equal to 20 kHz), in the subsonic frequency range (i.e. less than 20 Hz), or in the ultrasonic frequency range (above 20 KHz). For example, in an embodiment of the invention, the vibration may be in the frequency range 0.01 MHz to 10 MHz.

In this respect, it will be appreciated that the term ‘acoustic’ (e.g. in ‘non-linear acoustic non-destructive testing’) includes, for example, subsonic, sonic, and ultrasonic frequencies.

It will be appreciated that any reference to the unit hertz (Hz) is to the unit s⁻¹, i.e. the reciprocal of one second.

The vibration is a periodic vibration. The vibration may have a varying or fixed period (i.e. a varying or fixed frequency), as discussed in relation to each of the embodiments described below.

A second transducer, in the form of a vibration detector 5 is configured to detect the response of the testpiece 3 to the excitation vibration applied by the acoustic vibration generator 2. In the currently described embodiment the vibration detector 5 is a laser vibrometer, configured to measure the velocity of the vibrational response of a test location on the testpiece 3, to the excitation vibration. However, it will be appreciated that any suitable type of vibration detector may be used, including a laser vibrometer, accelerometer, or microphone, for example. It will also be appreciated that the response at a plurality of points on the testpiece 3 may be measured.

Furthermore, it will be appreciated that the first and second transducers 3, 5 may be formed by a single transducer.

A mains electrical power supply 4 is connected to the acoustic vibration generator 2 and to the vibration detector 5, to provide electrical power to them.

The testing apparatus 1 further comprises an analysis and control unit 6, which comprises input devices 7, in the form of a keyboard and mouse, for receiving input commands. It will be appreciated that any suitable input device(s) may be used, for example a touchscreen may be used instead of, or in addition to, the keyboard and mouse.

The input devices 7 are operatively connected to a central processing unit (CPU) 8, which is operatively connected to a memory 9. The CPU 8 comprises computer hardware programmed with suitable software.

An output of the CPU 8 is operatively connected (via a wired or wireless connection) to an output device 10, in the form of a computer display, for displaying a user interface, as well as the results of the testing. It will be appreciated that any suitable output device(s) may be used, for example a screen of a tablet, mobile phone etc.

The analysis and control unit 6 further comprises a controller 11. An output of the CPU 8 is operatively connected to an input of the controller 11. An output of the controller 11 is operatively connected to an input of the acoustic vibration generator 2.

The vibration detector 5 is operatively connected, via an analogue to digital convertor (ADC) 12, to an input of the CPU 8.

In use, a user inputs commands to the analysis and control unit 6 via the input devices 7. These input commands pass to the CPU 8 which then generates output signals to the controller 11, which generates control signals that pass to the acoustic vibration generator 2 to control the excitation vibration produced by the acoustic vibration generator 2, in dependence on the input commands.

The vibration detector 5 detects and measures the structural vibrational response of the testpiece 3, at the test location, to the excitation vibration produced by the acoustic vibration generator 2 and provides this: information in a measurement signal that is sent to an input of the CPU 8 (via the ADC 12).

The CPU 8 is configured, by a suitable configuration of hardware and software, to analyse the measurement signal (in accordance with the methods described below) and outputs the results of the analysis to the computer display 10, for review by a user.

It will be appreciated that the above-described hardware of the apparatus 1 is generally known and so will not be described in any further detail. Furthermore, it will be appreciated that many different variations of the hardware could be implemented by the skilled person to carry out the invention and that the invention is not limited to use of the specific hardware shown and described.

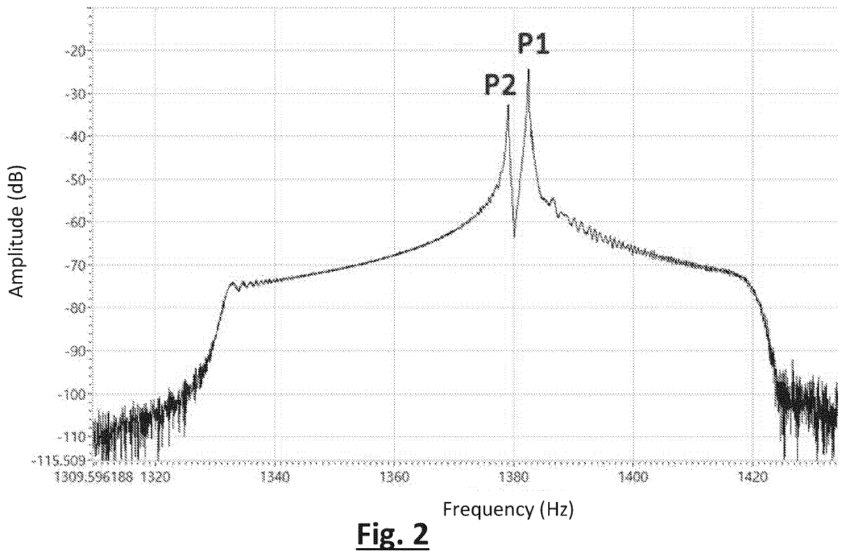

Through frequency sweep with ultra-fine resolutions, during non-linear acoustic NDT, the inventors have identified the presence of multiple response peaks (i.e. peaks in the variation of the amplitude of the vibrational response of the testpiece (i.e. peaks in the variation of the amplitude of velocity, acceleration, displacement, etc., to an input excitation vibration, with the frequency of the excitation), very closely-spaced in the frequency domain, visible only with ultra-fine resolution. The inventors have identified that these multiple response peaks can be caused by one or more phenomena. In this respect, the inventors have identified that the multiple response peaks may be caused by ‘degenerate modes’, which are two or more eigenmodes at nominally identical frequencies. In a real-world testpiece, it is possible that these degenerate modes will not occur at identical frequencies due to anisotropy of the testpiece, for example due to differences in the geometry and/or material properties of the testpiece in different dimensions. Such differences may be due to the manufacturing process, for example in an additively manufactured testpiece where the orientation of the build layers imparts differing structural moduli or densities in different dimensions. If these degenerate modes are at slightly different frequencies, there will be more than one response peak at or near the true resonance frequency. This is illustrated in FIG. 2, which shows the presence of multiple resonance peaks P1 and P2 caused by a vibration of a testpiece.

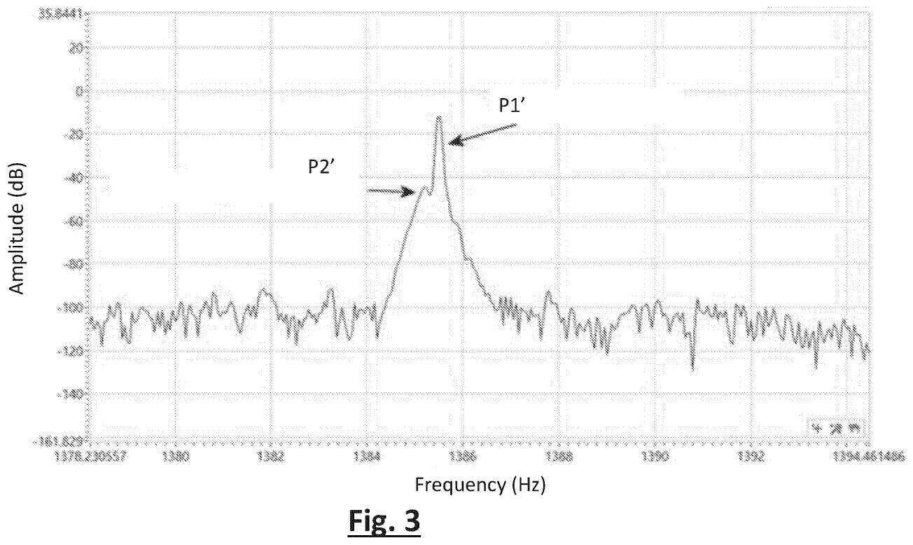

In some real-world cases, the second (or third) peak will not be obvious but rather it will be obscured in the roll-off of the more obvious peak. There is then a risk that this ‘hidden’ degenerate mode will not be detected in the analysis, and erroneous or spurious results will ensue. This is illustrated in FIG. 3, which shows the presence of a first response peak P1′, which is a true resonance peak, at a true resonance frequency of the testpiece, caused by the principal mode of vibration, and a second response peak P2′ caused by a degenerate mode, that is closely spaced from the true resonance peak P1′ and so may act to obscure the true resonance peak P1′.

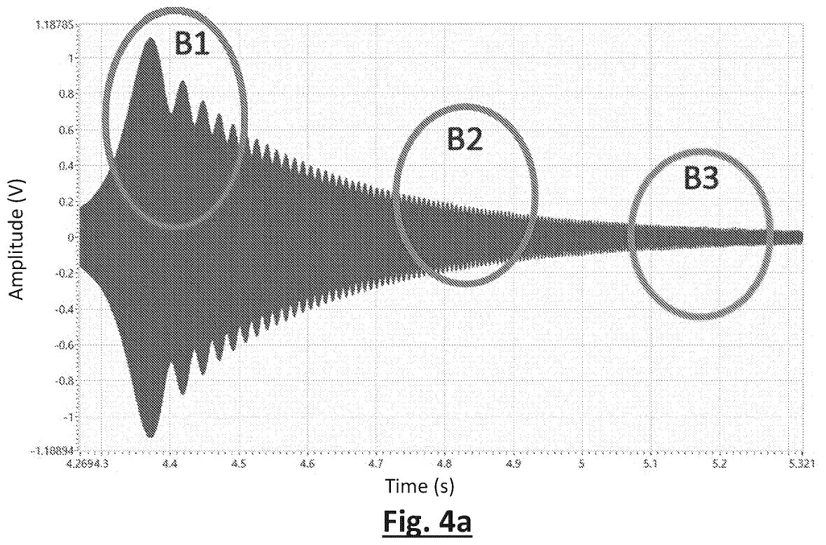

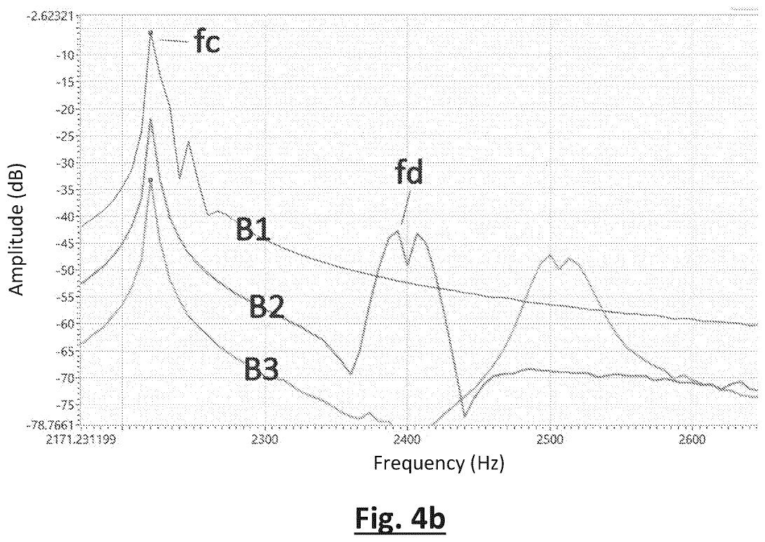

The inventors have also identified that, when a frequency sweep is used (i.e. exciting the testpiece across a range of frequencies of vibration), for example when trying to identify a resonance frequency, if this sweep is executed too rapidly, such that the time constant of the resonant testpiece is too long for the response of the testpiece to reach equilibrium before the instantaneous frequency (f_{c}) is incremented (or decremented), then the testpiece will continue to respond at that frequency f_{c} while being stimulated at a new instantaneous frequency (f_{d}). With reference to FIGS. 4a and 4b, this will manifest as intermodulation or ‘beating’ between these two frequencies f_{c} and f_{d} in the time domain or as two very closely-spaced peaks in the frequency domain, in addition to (f_{c}+/−f_{d}) (the lines labelled B1, B2 and B3 in FIG. 4b correspond to the regions labelled B1, B2 and B3 in FIG. 4a respectively).

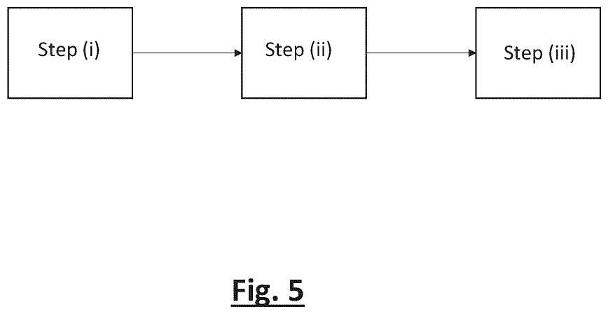

Referring to FIG. 5, there is shown a flow-chart showing the general steps in a method of non-linear acoustic non-destructive testing of a testpiece 3, according to an embodiment of the invention.

These steps are as follows:
(i) Determining a resonance frequency of a testpiece by applying at least one excitation vibration to the testpiece and analysing a vibrational response of the testpiece to the at least one excitation vibration;
(ii) Applying at least one excitation vibration to the testpiece at the determined resonance frequency and/or over a range of frequencies that includes the determined resonance frequency, and
(iii) Determining if the testpiece has one or more flaws by analysing a vibrational response of the testpiece, to the at least one excitation vibration in step (ii), for non-linear behaviour.

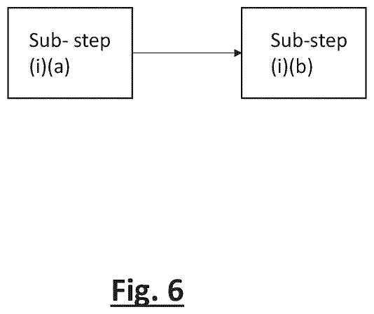

Step (i) will now be described in more detail, with reference to FIG. 6, which is a flow-chart showing the sub-steps of step (i).

In the first sub-step (i)(a), the acoustic vibration generator 2 applies a first excitation vibration to the testpiece 3 at a location on the testpiece 3, to vibrate the testpiece 3 over a first frequency range, by performing a first frequency sweep (i.e. the excitation vibration is applied across a first range of frequencies), at a first frequency resolution, to identify all resonance frequencies of interest. The amplitude of the applied excitation vibration is substantially constant, across the frequency range of the applied excitation vibration.

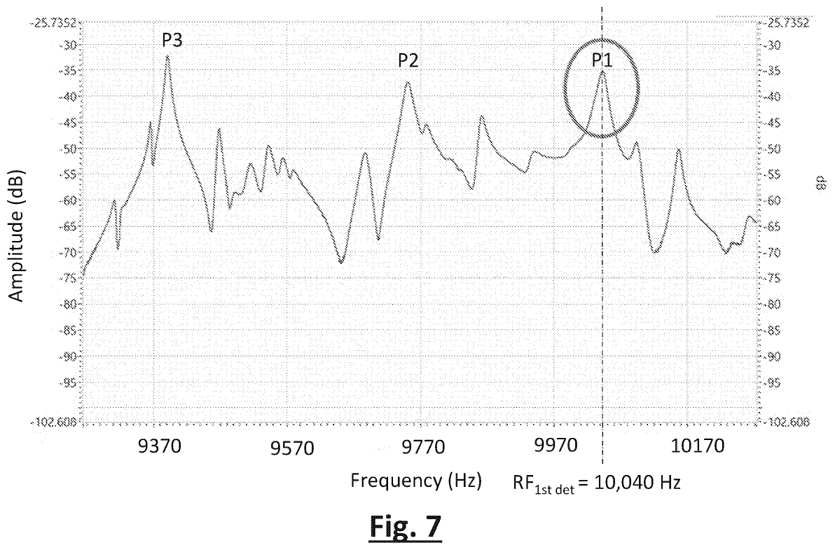

A vibrational response, in the form of the variation of the amplitude of the velocity (dB) (decibel) of the test location on a first testpiece 3, with the frequency (Hz) of vibration of the testpiece 3 at the test location, in response to the first excitation vibration, is shown in FIG. 7.

As shown in FIG. 7, the first frequency sweep is a wide-band with frequency range being from sweep, the first approximately 9,100 Hz to approximately 10,400 Hz. The first frequency resolution is 0.01 Hz (i.e. 10 mHz).

Multiple response peaks are produced (e.g. labelled P1, P2, P3 in FIG. 7) due to different modes of vibration of the testpiece 3.

In the currently described embodiment, the vibrational response is the variation of the amplitude of the velocity (dB) of the test location on the first testpiece, with the frequency (Hz) of vibration of the testpiece at the test location, in response to the first excitation vibration. In this respect, the vibrational response value is the amplitude of the velocity (dB) of the test location on the first testpiece.

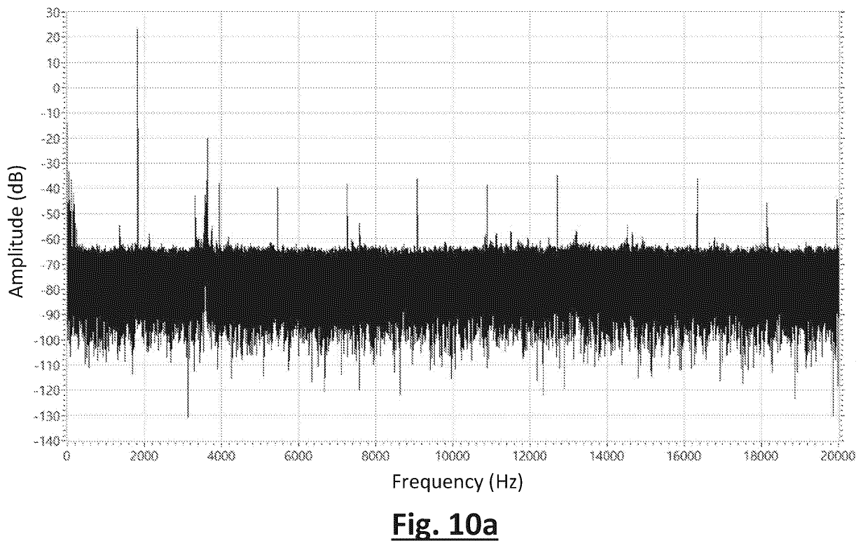

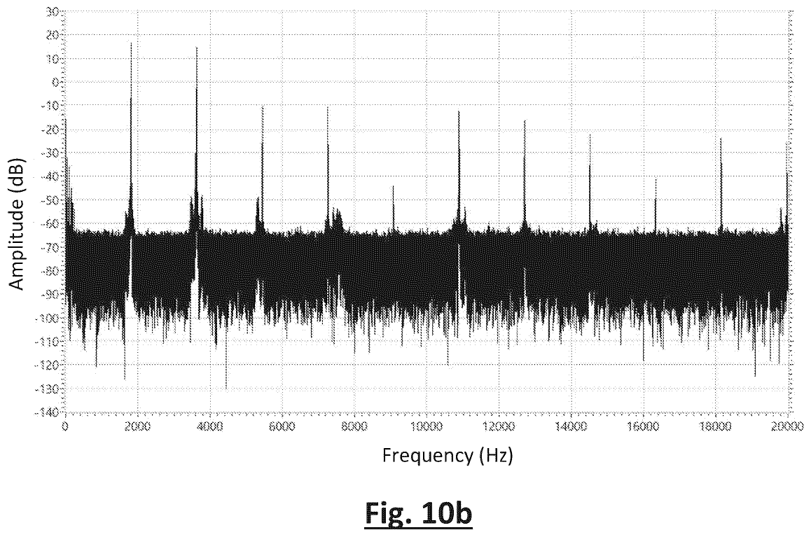

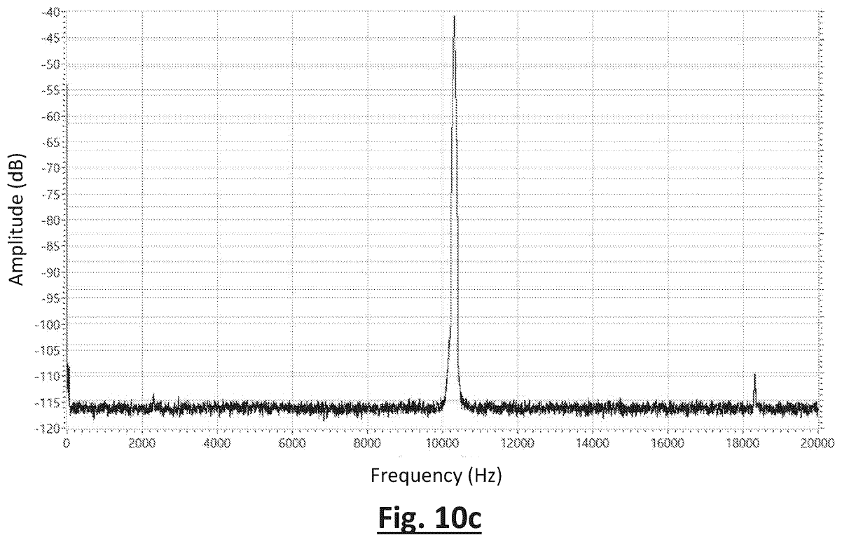

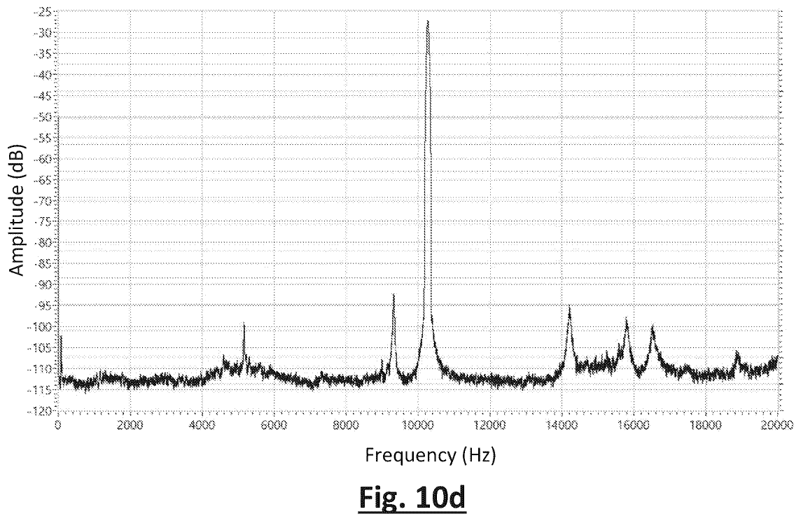

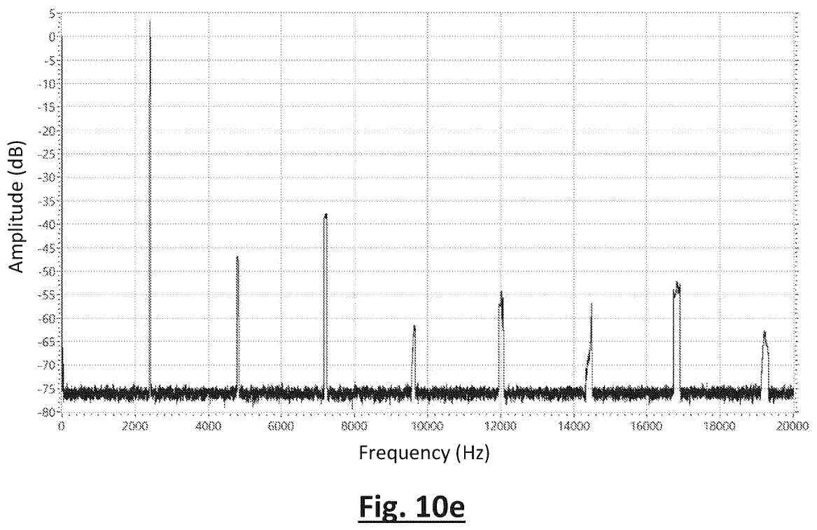

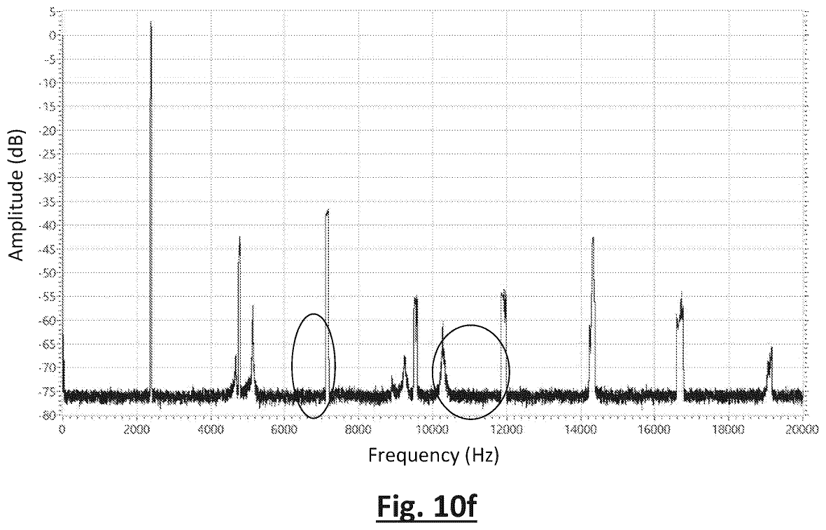

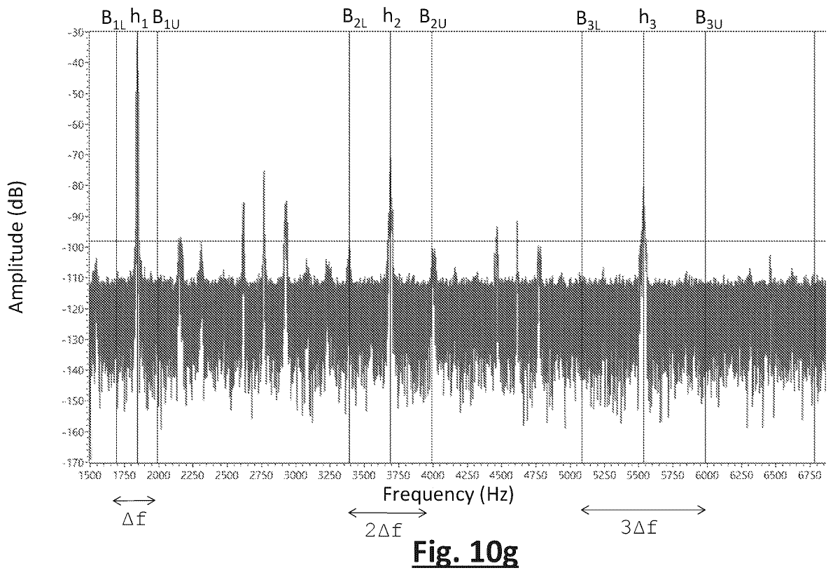

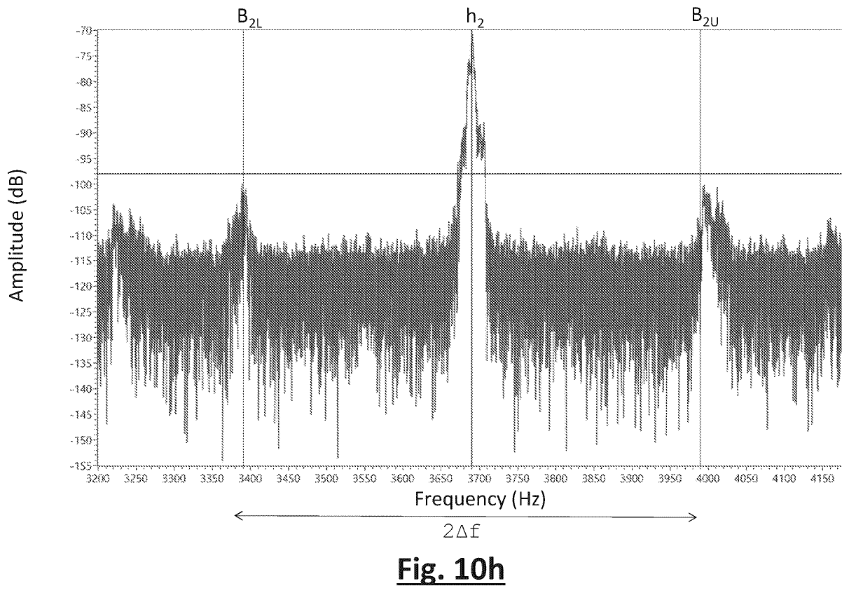

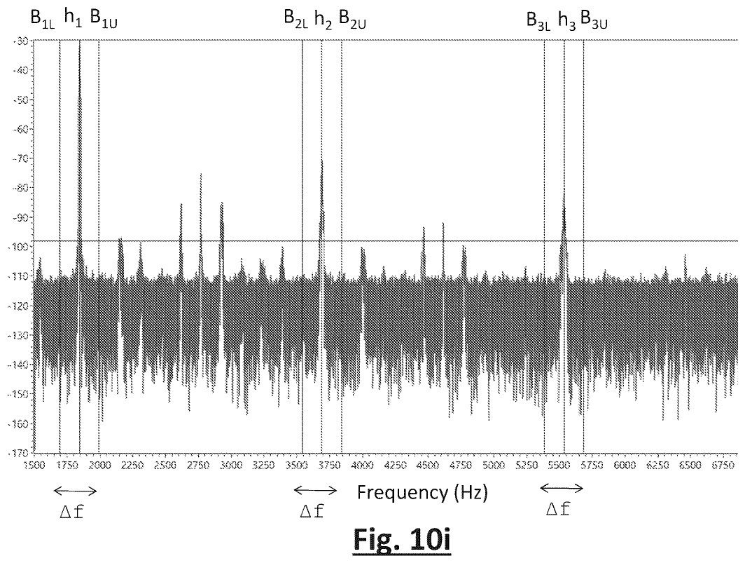

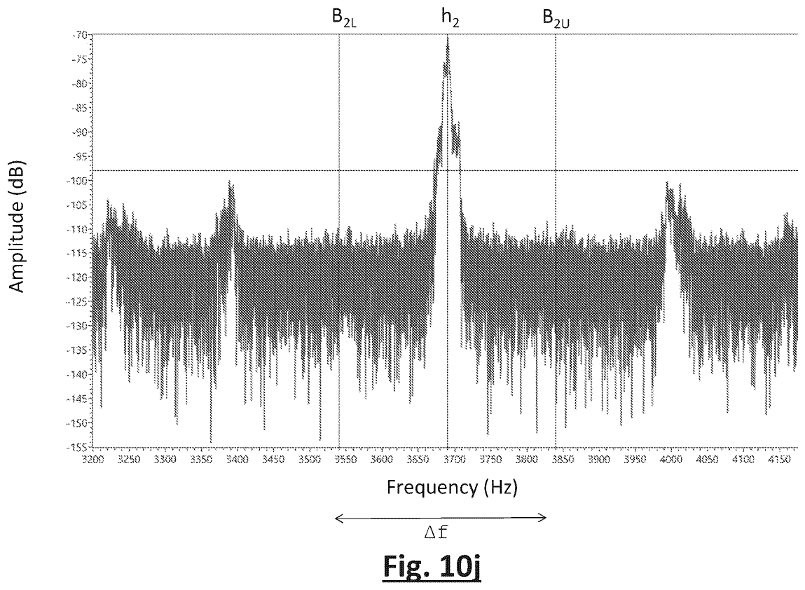

In FIGS. 7 and 10a to 10j, the amplitude of the velocity (dB) is calculated by:

$$A = 20 \times {log}_{10} ( V / Vref ) \qquad Equation 1$$

### Where:

A is the amplitude of the velocity (dB)
V is an uncalibrated root mean square (rms) voltage (V) proportional to velocity, and
Vref is a reference voltage, which is 1 volt (V).

However, it will be appreciated that a vibrational response value may be any value illustrative of the vibrational response of the testpiece to the respective excitation vibration. For example, the vibrational response value may be representative of velocity, acceleration, displacement, etc. of one or more locations on the testpiece, in response to the respective excitation vibration.

The vibrational response value may, for example, be a true value, normalised value, logarithmic value, a value transformed using a Fast Fourier Transform (FFT) etc. The vibrational response may, for example, be a variation of one or more of these values in the frequency and/or time domain (e.g. the variation of one or more of these values with the frequency of the respective excitation vibration and/or with time following or during the respective excitation vibration, for example).

In the currently described embodiment, the amplitude and frequency of the response peaks are each determined using a Fast Fourier Transform and by determining the peak amplitude and phase. However, it will be appreciated that any suitable method of determining a peak (and the frequency at which the peak occurs) may be used.

In the currently described embodiment, the response peaks, and the response peak frequencies, (i.e. the response frequencies at which the response peaks occur) are identified and determined by the CPU 8, which is configured through suitable hardware and software, to identify the peaks (and the frequency at which the peaks occur). Alternatively, or additionally, the response peak and the response peak frequency may be determined by a user, for example by a user viewing an output (e. g. a graph) of the vibrational response and visually determining the response peaks and the response frequency at which they occur.

In the currently described embodiment, a response peak (circled and labelled P1 in FIG. 7) of interest is selected and the response frequency at which it occurs is determined (as described above).

The selection of a response peak may be based on which response peak will be the least complex to work with (e.g. the response peak of the lowest frequency) and/or based on numerical modelling, for example.

In the currently described embodiment, the selection of the response peak of interest is done automatically, by a computer program (that the CPU 8 is programmed with), configured to select a response peak based on defined criteria (e.g. that would deduce which response peak would be the least complex to work with, for example based on numerical modelling).

Alternatively, additionally, the selection of the response peak of interest may be done manually, by a user inputting which response peak is of interest, for example using the input device 7.

In the currently described embodiment, the selected response peak is determined to occur at an amplitude value of −35 dB and at a frequency of 10,040 Hz. In this respect, the CPU 8 makes a first determination of a resonance frequency of the first testpiece (RF_{lst det}) to be 10,040 Hz and outputs this to the output device 10.

In a second sub-step (i)(b), a second excitation vibration is applied to the testpiece 3 at, and/or over a frequency range that includes, the first determination of the resonance frequency in step (i)(a) and a second determination of the resonance frequency is made from an analysis of a vibrational response of the testpiece to the second excitation vibration. This may be done by a variety of different methods.

In a first method of implementing the second sub-step (i)(b), the second excitation vibration is applied over a range of frequencies that includes the first determination of the resonance frequency (of 10, 040 Hz) and is at a second frequency resolution that is finer than the first frequency resolution (i.e. the frequency resolution the of first excitation vibration).

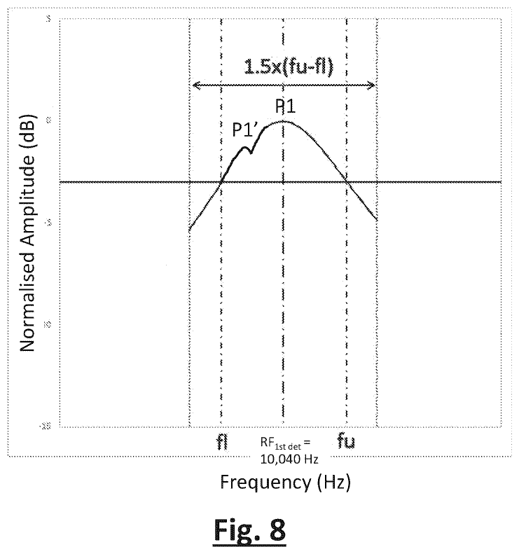

In this respect, with reference to FIG. 8, the second excitation vibration is performed on the first testpiece 3, centred on the first determination of the resonance frequency (of 10,040 Hz). In the currently described embodiment, this is a range of frequencies defined by the lower (fl) and upper (fu) half-power frequencies. In this respect, the peak of the response is normalised to 0 dB. The half-power frequencies are located at −3 dB. These frequencies locate the peak conveniently and confidently between them. The range is 1.5×(fu−fl) (see FIG. 8). The multiplier of 1.5× ensures that the entire range of frequencies between the lower (fl) and upper (fu) half-power frequencies is covered. However, it will be appreciated that any suitable range may be used that includes the first determination of the resonance frequency.

The frequency resolution of the second excitation vibration is 0.00001 Hz (i.e. 10 μHz), i.e. the frequency resolution of the second excitation vibration is finer than that of the first excitation vibration.

The finer frequency resolution of the second excitation vibration allows the vibrational response of the testpiece 3 to the second excitation vibration to be analysed with greater accuracy to determine if the first determined resonance frequency (RF_{lst det}) is a true resonance frequency (based on the vibrational response to the second excitation vibration). In this respect, the vibrational response to the second excitation vibration is analysed for response peaks (as for the first excitation vibration) within the frequency range of the second excitation vibration, to determine if the response peak is a true resonance peak (based on the vibrational response to the second excitation vibration).

This analysis may be done in a variety of ways. In the currently described embodiment, the vibrational response is analysed to determine if the selected response peak is the maximum amplitude response peak in the vibrational response to the second excitation vibration, within the frequency range of the second excitation.

If this is determined to be the case then the second determination of the resonance frequency is determined to be the same as the first determination of the resonance frequency.

If this is determined not to be the case then the vibrational response to the second excitation vibration is analysed to identify a further response peak that is determined to be a true resonance peak, based on the vibrational response to the second excitation vibration. A second determination of the resonance frequency is made to be the frequency at which the further response peak is determined to occur at.

The CPU 8 then outputs a signal containing the second determination of the resonance frequency, to the output device 10.

In this case, as shown in FIG. 8, in the vibrational response to the second excitation vibration, there are two response peaks, P1 and P1′.

P1 corresponds to the response peak P1 in the vibrational response to the first excitation vibration. P1′ is a split peak due to a degenerate mode (anisotropy) and/or one or more beat frequencies, revealed by the second excitation vibration.

The selected response peak P1, from the first excitation vibration, is determined to be the maximum amplitude response peak in the vibrational response to the second excitation vibration, within the frequency range of the second excitation vibration. Accordingly the selected response peak P1 is determined to be a true resonance peak (based on the vibrational response to the second excitation vibration). Therefore the second determination of the resonance frequency is made to be the same as the first determination of the resonance frequency, namely 10,040 Hz.

The steps of the first and second excitation vibrations, and the respective analyses of the vibration response to these excitation vibrations, may be repeated, by performing successive frequency sweeps centred on the resonance frequency identified in the previous sweep, with a finer frequency resolution than the previous frequency sweep, to hone-in on the true resonance frequency.

In a further embodiment, the velocity of the response of the testpiece 3 (i.e. its variation with time) is measured using the vibration detector 5. The velocity of the acoustic vibration generator 2 (i.e. its variation with time) is determined from the voltage of an amplifier of the acoustic vibration generator 2. The velocity of the response of the testpiece 3 is then divided by the velocity of the acoustic vibration generator 2 to produce a ‘transfer function’ of the testpiece 3 (the ratio of output response/input excitation) as an amplitude and phase at each input excitation frequency. However, the transfer function need not necessarily be velocity/velocity, it could, for example, be velocity/force or velocity/acceleration.

The transient response of the testpiece 3 is measured. In this respect, the acoustic vibration generator 2 excites the testpiece 3 with a short step function and the decay time constant of the response of the testpiece 3 is measured by the vibration detector 5.

A first excitation vibration, in the form of a full-band frequency sweep is performed, at a first frequency resolution, to identify the resonance peaks of interest. This is done as a Fast Fourier Transform (FFT) of the vibrometer 2 response to a white noise source, to avoid any ringing effects during a frequency sweep.

A response peak is identified and selected to provide a first determination of the resonance frequency. As for the previous embodiment, a second excitation vibration is then performed on the testpiece 3, centred on the first determination of the resonance frequency and a second determination of the resonance frequency is made. The second excitation vibration is in the form of a second frequency sweep is then performed (using a continuous wave sweep), at a finer frequency resolution to the first frequency sweep. As with the previous embodiment, this provides the ability to control the frequency resolution around the peak of interest to as fine a resolution as required and the FFT should average out noise or ringing.

The above method steps may allow for the identification of the resonance frequency to take account of potentially obfuscating factors, such as degenerate modes (due to anisotropy) and/or beat frequencies.

In a second method of implementing the second sub-step (i)(b), the second excitation vibration is applied at a single frequency, namely the frequency of the first determination of the resonance frequency from step (i)(a).

A vibrational response of the testpiece to the second excitation vibration is then analysed to determine if a beat frequency is present and, based on whether or not a beat frequency is determined to be present, a second determination of the resonance frequency is made.

In this respect, a determination is made as to whether a beat frequency is present. As discussed above, a beat frequency occurs where the time constant of the resonant testpiece is too long for the response of the testpiece to reach equilibrium before the instantaneous frequency (f_{c}) is incremented (or decremented). Accordingly the testpiece will continue to respond at that frequency f_{c} while being stimulated at a new instantaneous frequency (f_{d}). This will manifest as intermodulation or ‘beating’ between these two frequencies f_{c} and f_{d} in the time domain or as two very closely-spaced peaks in the frequency domain, in addition to (f_{c}+/−fa).

If a beat frequency is present then this indicates that the first determination of the resonance frequency is not the true resonance frequency.

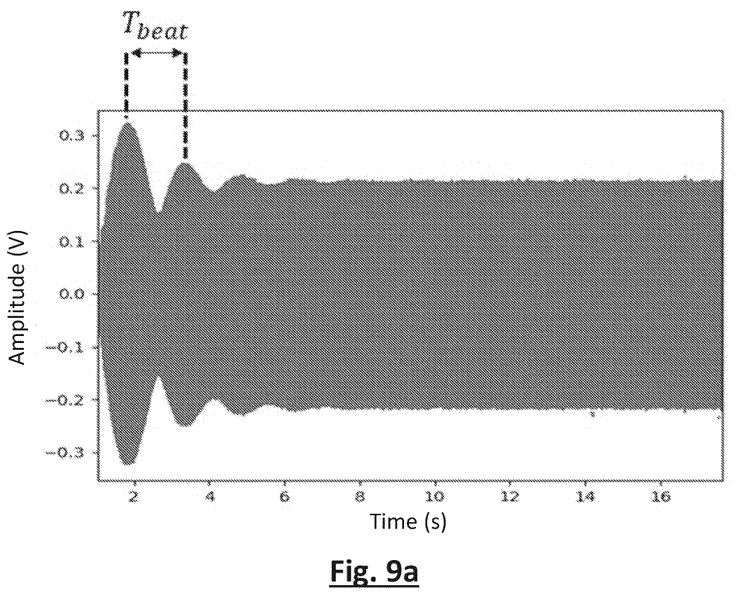

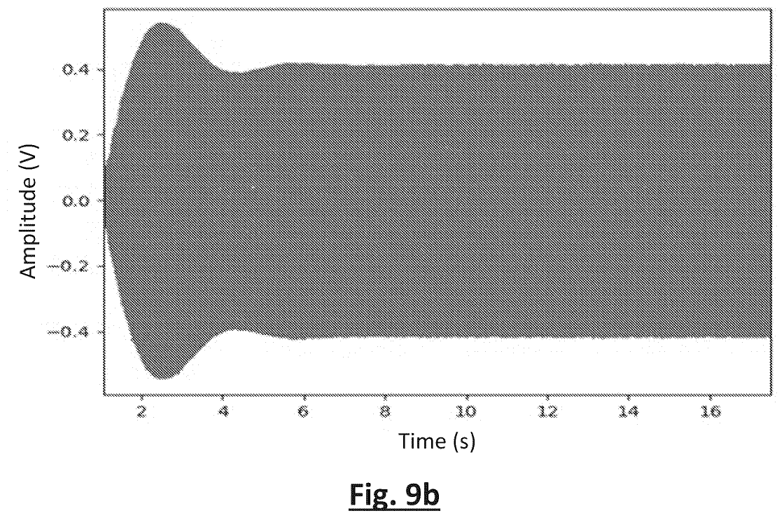

FIG. 9a is a graph showing the variation of the amplitude of the velocity (V) of a test location on a second testpiece, with time(s) to an excitation vibration at a single frequency, namely the frequency of a first determination of a resonance frequency of the second testpiece by carrying out any of the above embodiments of step (i)(a) for the second testpiece.

A shown in FIG. 9a, a beat frequency is determined to be present, thereby showing that the first determination of the resonance frequency is not the true resonance frequency.

In this case, the beat frequency (F_{beat}) is calculated from the response of the testpiece to the single excitation frequency (at the first determination of the resonance frequency). In this regard, with reference to FIG. 9a, the time (T_{beat}) between successive amplitude peaks is measured and the beat frequency (F_{beat}) is calculated from:

$${F}_{b e a t} = \frac{1}{{T}_{b e a t}} \qquad Equation 2$$

Where:
F_{beat} is the beat frequency (hertz (Hz))
T_{beat} is the beat period (seconds(s))

The true resonance frequency (RFₜᵣᵤₑ) is then calculated from:

$$R {F}_{true} = {F}_{e x c i t a t i o n} \pm {F}_{b e a t} \qquad Equation 3$$

Where:
RFₜᵣᵤₑ is the true resonance frequency (hertz (Hz))
F_{excitation} is the single frequency excitation carried out (at the first determined resonance frequency) (hertz (Hz))
F_{beat} is the beat frequency (hertz (Hz))

As a test, to check that the determined true resonance frequency (RFₜᵣᵤₑ) is correct, the testpiece 3 may be excited at the determined true resonance frequency (RFₜᵣᵤₑ). If no beat frequency is then present (e.g. as shown in FIG. 9b) then this indicates that the determined true resonance frequency (RFₜᵣᵤₑ) is correct.

The second determination of the resonance frequency is therefore the determined true resonance frequency.

Where an excitation vibration is applied to the testpiece, the vibrational response of the testpiece to the excitation vibration is analysed to determine if a beat frequency is present and this is accounted for when making the respective determination of resonance frequency.

In step (ii) of the method, at least one excitation vibration is applied to the testpiece to vibrate the testpiece at the determined resonance frequency and/or over a range of frequencies that includes the determined resonance frequency.

This increases the input energy into the testpiece and so increases the likelihood of inducing non-linear behaviour in a flawed testpiece.

In this respect, where a second determination of the resonance frequency is made (as above), the determined resonance frequency, referred to in steps (i) and (ii) is the second determination of the resonance frequency.

In step (iii) of the method, the vibrational response of the testpiece, to the at least one excitation vibration in step (ii), is analysed for non-linear behaviour, to determine if the testpiece contains one or more flaws.

Steps (ii) and (iii) may be implemented in a variety of methods.

The inventors have identified that the presence of harmonics of the determined resonance frequency indicates non-linear behaviour. Accordingly, in a further embodiment, an analysis for harmonics of the second determination of the resonance frequency is performed, i.e. for response peaks at integer multiples of the second determination of the resonance frequency.

In this respect, the testpiece is excited at the second determination of the resonance frequency from step (i) and the vibrational response of the testpiece is analysed for harmonics of the second determination of the resonance frequency.

FIG. 10b is a graph showing the variation of the amplitude of the velocity (dB) of the test location on a flawed version of a third testpiece, with the frequency (Hz) of vibration of the testpiece at the test location, in response to an excitation vibration at a resonance frequency of the testpiece, as determined in step (i) (which in this case is 1.8 kHz), to examine for harmonics. Alternatively an excitation vibration over a range that includes the determined resonance frequency may be used.

As shown in FIG. 10b (with comparison to FIG. 10a for a non-flawed version of the third testpiece), significantly increased harmonics are present indicating non-linear behaviour of the testpiece, due to one or more flaws in the testpiece.

The presence of harmonics is determined by analysing for response peaks at the harmonic frequencies (e.g. 3.6 kHz, 5.4 KHz, 7.2 kHz, etc.).

In this case, the presence of harmonics is determined and so a determination is made that the testpiece has one or more flaws. A signal representative of this determination is output to the output device 10. This signal may take any form.

The inventors have also identified that the presence of interharmonics indicates non-linear behaviour, i.e. the presence of a response amplitude peak at any frequency which is not an integer multiple of the determined resonance frequency.

In this respect, interharmonics is a known phenomenon in an entirely unrelated field: that of power supply engineering, where interharmonics are an undesirable ‘noise’ to be avoided where possible. However the inventors have identified that, in non-destructive testing, the presence of interharmonics is an indicator of non-linear behaviour.

Accordingly, a further embodiment, an analysis for interharmonics is performed. The testpiece is excited at the second determination of the resonance frequency in step (i) and the vibrational response of the testpiece is analysed for interharmonics, i.e. the presence of response peaks at frequencies which are not integer multiple of the second determined resonance frequency. Alternatively an excitation vibration over a range that includes the second determined resonance frequency may be used.

FIG. 10d is a graph showing the variation of the amplitude of the velocity (dB) of the test location on a flawed version of a fourth testpiece, with the frequency (Hz) of vibration of the testpiece at the test location, in response to an excitation vibration at a resonance frequency of the testpiece, as determined in step (i) (i.e. the second determined resonance frequency) (which in this case is 10.2 kHz), to examine for interharmonics. Alternatively an excitation vibration over a range that includes the determined resonance frequency may be used.

As shown in FIG. 10d (with comparison to FIG. 10c for a non-flawed version of the fourth testpiece), interharmonics are present indicating non-linear behaviour of the testpiece, due to one or more flaws in the testpiece.

The presence of interharmonics is determined by analysing for response peaks at frequencies which are not integer multiples of the second determined resonance frequency.

In this case, the presence of interharmonics is determined, by the detection of response peaks at frequencies which are not integer multiples of the second determined resonance frequency (10.2 kHz), for example the response peaks shown in FIG. 10d at approximately 9.3 kHz, 14.3 kHz, 15.8 kHz and 16.6 kHz and so a determination is made that the testpiece has one or more flaws. A signal representative of this determination is output to the output device 10. This signal may take any form.

In order to mask the harmonic content and expose the interharmonic content, to analyse for interharmonics, the inventors have identified that guard bands may be defined around each of the harmonics. The vibrational response within each guard band is masked from the analysis for interharmonics, i.e. it is not taken into account in the analysis for interharmonics.

The inventors have identified that one approach could be to use a guard band, around each harmonic, where the bandwidth of the guard band increases in proportion to the order of the harmonic, i.e. if the bandwidth (Hz) of the guard band around the fundamental (first harmonic) (h1) is ΔF, then the bandwidth (Hz) of the guard band around the second harmonic (h2) would be 2ΔF, and the bandwidth of the guard band around the third harmonic (h3) would be 3ΔF, and so on. Such a method is as shown in FIG. 10g, which illustrates the increment in guard bandwidth (Hz) for the first three harmonics (at approximately 1850 Hz, 3700 Hz, and 5550 Hz respectively).

In FIGS. 10g to 10j, each harmonic is labelled as hₙ, where n is the order of the harmonic, with the frequency of the lower and upper ends of the guard bandwith (Hz) being labelled B_{nL} and B_{nU} respectively.

FIG. 10h corresponds to FIG. 10g, but zoomed in around the second harmonic (at approximately 3700 Hz). The inventors have identified that the interharmonic content at ~3400 Hz and ~4000 Hz is partially included in the masking guard band, with bandwith 2ΔF, thereby corrupting the quantification of the interharmonics, which can occur to a significant extent.

Accordingly, with reference to FIG. 10i, in an embodiment of the invention, the above steps (i) and (ii) are carried out as described above. However, in step (iii), the analysis for interharmonics of the determined resonance frequency comprises determining a plurality of harmonics (h₁, h₂, h₃) of the determined resonance frequency. This determination is made in a corresponding way to that described above, in relation to the determination of the presence of harmonics, by analysing for response peaks at the harmonic frequencies.

In this case, the fundamental (first harmonic) (h₁) is at approximately 1850 Hz, the second harmonic (h₂) is at approximately 3700 Hz and the third harmonic (h₃) is at approximately 5550 Hz.

It will be appreciated that the first harmonic is the fundamental.

In respect of each of said plurality of harmonics, the method comprises masking the vibrational response, from the analysis for interharmonics (i.e. it is not taken into account in the analysis for interharmonics), within a guard band that contains the harmonic, wherein the guard bands have substantially the same bandwidth (Δf). In the currently described embodiment, the guard bands extend substantially the same frequency range above the frequency of the respective harmonic as each other and extend substantially the same frequency range below the frequency of the respective harmonic as each other.

In the currently described embodiment, the guard band for each harmonic is substantially centred on the frequency of the respective harmonic. Alternatively, the guard bands may not be substantially centred on the frequency of the respective harmonic.

In the currently described embodiment, the bandwidth (Δf) of each guard band is approximately 300 Hz.

As shown in FIG. 10j (which corresponds to FIG. 10i, but zoomed in around the second harmonic), the use of the guard bands of substantially the same bandwith (Δf) avoids, or at least reduces, the inclusion of interharmonic content in the guard band, thereby avoiding, or at least reducing, consequent corruption of the interharmonic analysis.

The inventors have also identified that the presence of mode coupling indicates non-linear behaviour. Accordingly, in a further embodiment, an analysis for mode coupling is performed.

FIG. 10f is a graph showing the variation of the amplitude of the velocity (dB) of the test location on a flawed version of a fifth testpiece, with the frequency (Hz) of vibration of the testpiece at the test location, in response to an excitation vibration across a range of excitation frequencies that includes the resonance frequency of the testpiece as determined in step (i), to examine for mode coupling.

The testpiece is excited by an excitation vibration over a range of frequencies that includes the determined resonance frequency in step (i) (i.e. the second determined resonance frequency), which in this case is 2.4 kHz) and the response of the testpiece 3 is analysed for mode coupling. Alternatively, the excitation may be at the determined resonance frequency only.

As shown in FIG. 10f (with comparison to FIG. 10e for a non-flawed version of the fifth testpiece), mode coupling is present indicating non-linear behaviour of the testpiece, due to one or more flaws in the testpiece.

The presence of mode coupling is determined by analysing for response peaks at resonance frequencies of other modes of vibration of the testpiece, i.e. other modes of vibration than the mode of vibration due to said excitation vibration In this respect, there are two pairs of mode-coupled peaks, one pair either side of the 2nd harmonic (at 4.8 Hz) and one pair either side of the 4th harmonic (at 9.6 Hz).

It will be appreciated that the resonance frequencies of said other modes of vibration may be determined in any way (prior, or at the same time as, carrying out the above analysis for mode coupling), for example by one or more of modelling, analysis, measurement, etc.

In this case, the presence of mode coupling is determined, by the presence of said response peaks at resonance frequencies of other modes of vibration of the testpiece and so a determination is made that the testpiece has one or more flaws. A signal representative of this determination is output to the output device 10. This signal may take any form.

Each of the above analyses for harmonics, interharmonics and mode coupling may be performed manually (for example by visual inspection of a display of the response spectra) or automatically, using a computer algorithm configured to identify harmonics, interharmonics or mode coupling respectively).

Each time an excitation amplitude of a frequency sweep is changed, the above described method of determining whether a beat frequency is present is performed, so that the accurate resonance frequency is determined for each frequency sweep.

In an embodiment of the invention, the above method is repeated for a plurality of selected resonance frequencies and the results combined to determine if the testpiece is flawed.

Each of the above described methods may allow for the identification of the resonance frequency to take account of potentially obfuscating factors, such as degenerate modes (due to anisotropy) and/or beat frequencies.

This allows for an accurate determination of the resonance frequency of the testpiece to be made and for the excitation of the testpiece at the accurately identified resonance frequency, and/or within a range of frequencies that includes the identified resonance frequency, which will provide a relatively high input energy into the testpiece, thereby increasing the likelihood that any non-linear behaviour, due to one or more flaws in the testpiece, will be induced.

In the currently described embodiments, the flaws were cracks (which was subsequently determined by destructive testing). However, it will be appreciated that the method of the invention determines if a ‘flaw’ is present, without necessarily determining the specific type of flaw (e.g. whether it is a crack, contact defect, impact damage, etc). In this respect, the method is not limited to use with a specific type of flaw and may be used to determine if a testpiece has (one or more) flaw that produces said non-linear behaviour, from applied excitation vibration at a determined resonance frequency of the testpiece and/or over a range of frequencies that includes a determined resonance frequency of the testpiece.

It will be appreciated that numerous modifications to the above described design may be made without departing from the scope of the invention as defined in the appended claims.

For example, the resonance frequency of the testpiece may be determined without the above described methods of accounting for said potentially obfuscating factors and the testpiece then excited at the determined resonance frequency and/or over a range of frequencies that includes the determined resonance frequency to provide the non-linear analysis. In this case, only one excitation vibration may be required in step (i). However, it is preferred that the resonance frequency is determined, taking into account the potentially obfuscating factors, so as to provide an accurate identification of the resonance frequency.

It will be appreciated that the method can be implemented in any suitable way and does not have to be carried out by the test apparatus of the described embodiments.

Where in the foregoing description, integers or elements known, are mentioned which have obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the Independent claims.

1. A method of non-linear acoustic non-destructive testing of a testpiece comprising:
(i) Determining a resonance frequency of a testpiece by applying at least one excitation vibration to the testpiece and analysing a vibrational response of the testpiece to the at least one excitation vibration;
(ii) Applying at least one excitation vibration to the testpiece at the determined resonance frequency and/or over a range of frequencies that includes the determined resonance frequency, and
(iii) Determining if the testpiece has one or more flaws by analysing a vibrational response of the testpiece, to the at least one excitation vibration in step (ii), for non-linear behaviour.

2. A method according to claim 1 wherein step (iii) comprises determining if the testpiece has one or more flaws by analysing a vibrational response of the testpiece, to the at least one excitation vibration in step (ii), for interharmonics of the determined resonance frequency.

3. A method according to claim 2, wherein the analysis for interharmonics of the determined resonance frequency comprises determining a plurality of harmonics of the determined resonance frequency and, in respect of each of said plurality of harmonics, masking the vibrational response, from the analysis for interharmonics, within a guard band that contains the harmonic, wherein each guard band has substantially the same bandwidth.

4. A method according to claim 1 wherein step (iii) comprises determining if the testpiece has one or more flaws by analysing a vibrational response of the testpiece, to the at least one excitation vibration in step (ii), for mode coupling.

5. A method according to claim 1 wherein step (i) comprises:
(i)(a) Making a first determination of a resonance frequency of a testpiece by applying at least one excitation vibration to the testpiece and analysing a vibrational response of the testpiece to the at least one excitation vibration;
(i)(b) Determining if the first determination of resonance frequency is a true resonance frequency of the testpiece and, if it is determined not to be a true resonance frequency of the testpiece, performing an analysis to provide a second determination of the resonance frequency that is closer to, and/or at, the true resonance frequency.

6. A method according to claim 1 wherein:
step (i) comprises:
(i)(a) applying a first excitation vibration to the testpiece over a range of frequencies and making a first determination of a resonance frequency of the testpiece from an analysis of a vibrational response of the testpiece to the first excitation vibration;
(i)(b) applying a second excitation vibration to the testpiece at, and/or over a frequency range that includes, the first determination of the resonance frequency in step (i)(a) and making a second determination of the resonance frequency from an analysis of a vibrational response of the testpiece to the second excitation vibration;

7. A method according to claim 6 wherein step (i) comprises:
(i)(a) applying a first excitation vibration to the testpiece over a range of frequencies, at a first frequency resolution, identifying a response peak in the vibrational response, to the first excitation vibration and making a first determination of a resonance frequency of the testpiece to be the frequency at which the identified response peak occurs;
(i)(b) applying a second excitation vibration to the testpiece over a range of frequencies that includes the first determination of the resonance frequency from step (i)(a), and is applied at a second frequency resolution that is finer than the first frequency resolution, and analysing a vibrational response of the testpiece to the second excitation vibration to provide a second determination of the resonance frequency.

8. A method according to claim 6 wherein:
in step (i)(b), the second excitation vibration is at the first determination of the resonance frequency from step (i)(a), and wherein
step (i)(b) comprises analysing a vibrational response of the testpiece to the second excitation vibration to determine if a beat frequency is present and, based on whether or not a beat frequency is determined to be present, making a second determination of the resonance frequency.

9. A method according to claim 1 wherein step (iii) comprises determining if the testpiece has one or more flaws by analysing a vibrational response of the testpiece, to the at least one excitation vibration in step (ii), for harmonics of the determined resonance frequency.

10. A computer program product comprising instructions which, when the program is executed by a computer, cause the computer to carry out the method of claim 1.

11. An apparatus for non-linear acoustic non-destructive testing of a testpiece, wherein the apparatus comprises a computer configured to operate the apparatus to carry out the method of claim 1.

12. An apparatus according to claim 11, wherein the computer is configured to execute the computer program product according to claim 10.
